(19) United States
(12) Patent Application Publication
(10) Pub. No.: US 2009/0237943 A1
(43) Pub. Date: Sep. 24, 2009

(54) FLUSH MOUNT READING LIGHT

(75) Inventors: Glenn T. Schmidt, Selden, NY (US); David P. Eckel, Fort Salonga, NY (US); John R. Householder, Reading, MA (US)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: B/E Aerospace, Inc., Wellington, FL (US)

(21) Appl. No.: 12/262,488

(22) Filed: Oct. 31, 2008

Related U.S. Application Data
(60) Provisional application No. 60/984,792, filed on Nov. 2, 2007.

(51) Int. Cl. F21V 5/00

(52) U.S. Cl. 362/311.02; 362/311.01; 362/311.06

(57) ABSTRACT

A lighting system comprising a generally conical shaped optical housing having a focal point and a light source. The light source, for example, an LED, is disposed in the focal point of the optical housing. A lens surrounds at least a portion of the light source and encloses a cavity aligned with the light source. The top output surface of the lens is distal from the focal point of the optical housing. The optical housing is attached to an electrical board connected to the light source and an external housing at least partially encloses the optical housing, the light source and the electrical board.

### CROSS-REFERENCE TO RELATED PATENT APPLICATIONS

This patent application claims the benefit of U.S. Provisional Patent Application No. 60/984,792, filed Nov. 2, 2007, herein incorporated by reference.

### FIELD OF THE INVENTION

This invention pertains to a reading light and, more particularly, to a reading light installed in the passenger compartment of a vehicle such as an airplane, bus, or mobile home.

### BACKGROUND OF THE INVENTION

Reading lights for use in vehicles such as airplanes are well known in the art. These lights have used various well known forms of light sources including incandescent and florescent light in an attempt to provide light that is bright enough to illuminate a given area to allow a particular passenger to work or read while minimizing any disturbance or inconvenience to other passengers in a surrounding area. In order to design an effective reading light, the intensity of the light must be bright enough to allow a user to comfortably view whatever material they may be reading. Furthermore, the beam of light must be concentrated enough so as to illuminate a given area yet diffused enough to allow someone to look at the light without doing damage to the eye.

The introduction of light emitting diodes (LEDs) has resulted in new designs for reading lights. LEDs illuminate brighter than conventional light sources and therefore, have a brighter light beam when concentrated on a particular point. In order to compensate for the greater light intensity that result from an LED, a lighting system that allows the light from the LEDs to be diffused to a comfortable level would be an important improvement in the art.

### BRIEF SUMMARY OF THE EMBODIMENTS

The invention is generally directed to a lighting system comprised of an external housing, an optical housing, an optical surface and a light source. The invention provides a minimum and maximum luminance for a lighted area of a given radius at a given distance. In a preferred embodiment the lighting apparatus and system is comprised of a generally conical shaped optical housing having a focal point with a light source disposed in the focal point. The light source may be, for example, a single LED. A lens surrounds at least a portion of the light source and encloses a cavity aligned with the light source. The top output surface of the lens is distal from the focal point of the optical housing. The optical housing is attached to an electrical board connected to the light source and an external housing. The external housing at least partially encloses the optical housing, the light source and the electrical board.

### BRIEF DESCRIPTION OF THE DRAWINGS

The above-noted and other advantages of the invention will be apparent from the description of the invention provided herein with reference to the attached drawings in which:

FIG. 1 is a view of an embodiment of the invention in which a light source is disposed in a recessed portion of a lens with an internal cavity and in which the lens is surrounded by an optical housing attached to an electrical plate;

FIG. 2 is a view of the embodiment of FIG. 1 without the optical housing and the electrical plate;

FIG. 3 is a cross section view of the embodiment of FIG. 1;

FIG. 4 is an exploded view of an embodiment of the invention illustrating the embodiment of FIG. 1 and an external housing;

FIG. 5 is side view of an embodiment of the external housing;

FIG. 6 a perspective view of the external housing of FIG. 5;

FIG. 7 is a front view of the external housing of FIG. 6;

FIG. 8 is a cross section view of one embodiment of an LED light source;

FIG. 9 is a cross section view of a second embodiment of an LED light source;

FIG. 10 is a perspective view of an embodiment of an LED light source;

FIG. 11 is an embodiment in which an optical surface is comprised of a plurality of micro-lenses and in which a central indentation on the optical surface is used to reduce on-axis intensity of the light beam;

FIG. 12 is a view of another embodiment in which concentric rings on the optical surface aid in diffusing the light;

FIG. 13 is a view of an embodiment illustrating a convex lens disposed in the approximate center of the optical surface to increase on-axis light intensity;

FIG. 14 is a view of an embodiment showing an ellipsoidal mirror and central focus lens located within the housing;

FIG. 15 is a view of an embodiment having housing sidewalls that collimate the received light;

FIG. 16 is a listing of illumination patterns for the inventive light source;

FIG. 17 lists the new illumination levels plotted in FIG. 18; and

FIG. 18 is a representative comparison of old and new illumination levels.

### DETAILED DESCRIPTION OF THE EMBODIMENTS

The embodiment of the invention described below is not intended to be exhaustive or to limit the invention to the precise structure and operation disclosed. Rather, the embodiment described below has been chosen and described to explain the principles of the invention and its application, operation and use in order to best enable others skilled in the art to follow its teachings.

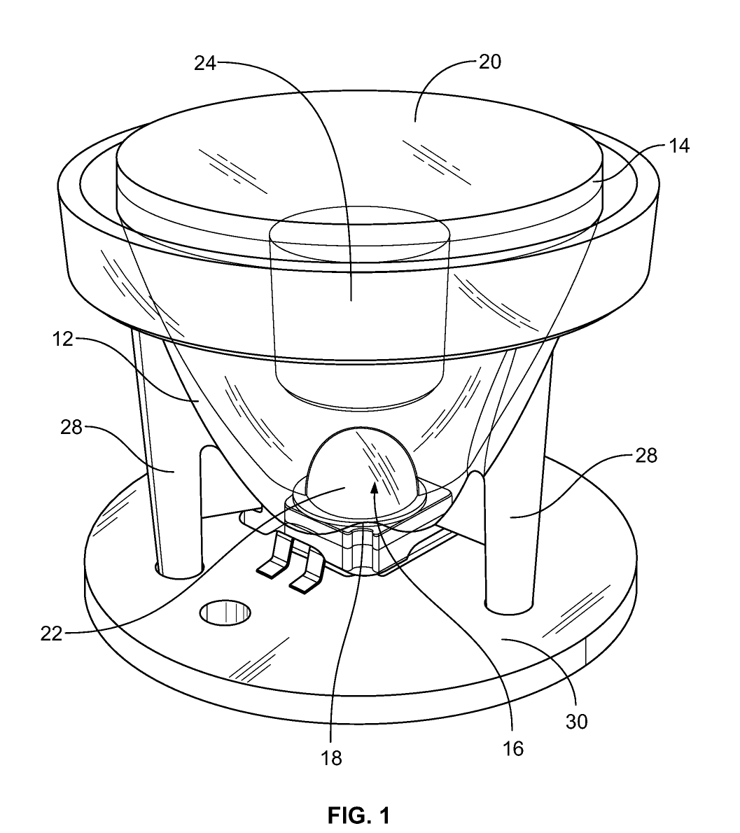

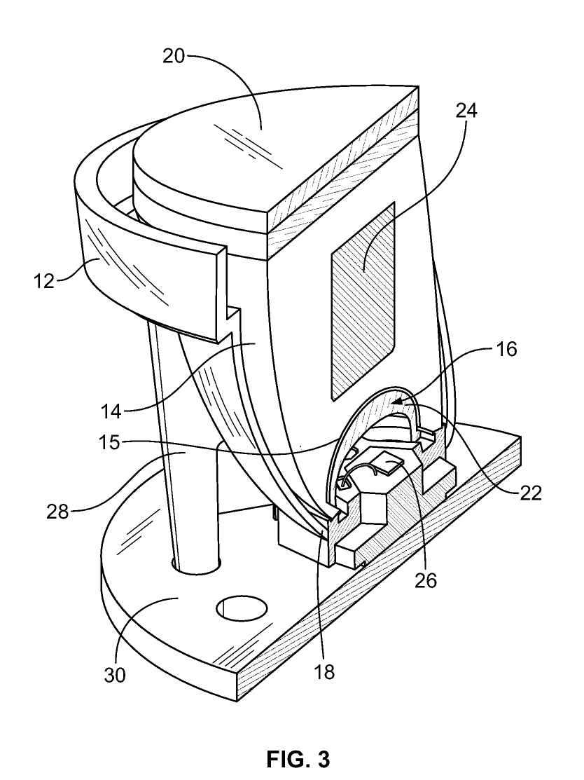

The invention is generally directed to a lighting system comprised of an external housing, an optical housing, an optical surface and a light source. The purpose of the lighting system is to provide a minimum and maximum luminance with a sharp cut-off of light for a lighted area of a given radius at a given distance. The preferred embodiment is illustrated in FIGS. 1-4. As shown in FIGS. 1 and 3-4, a generally conical shaped optical housing 12 surrounds an optical surface such as a lens 14. The light source 16 (best seen in FIGS. 1-3) is disposed in the focal point 18 of the optical housing 12 and is distal from the top output surface 20 of the lens 14. The lens in the preferred embodiment is generally conical in shape and encloses an air cavity 24 vertically aligned with the light source 16. The preferred lens has a bottom recessed portion 15 that surrounds at least a portion of the radiating portion 22 of the light source. In the preferred embodiment the lens is a solid integral lens (enclosing an air cavity) made of polycarbonate. Although, in other embodiments other suitable materials may be used and the lens may comprise multiple lenses stacked together. In the preferred embodiment the top output surface 20 of the lens is disposed distal from the focal point 18 of the optical housing 12 and is generally flat and of a larger diameter than the portion of the lens that surrounds the radiating portion of the light source.

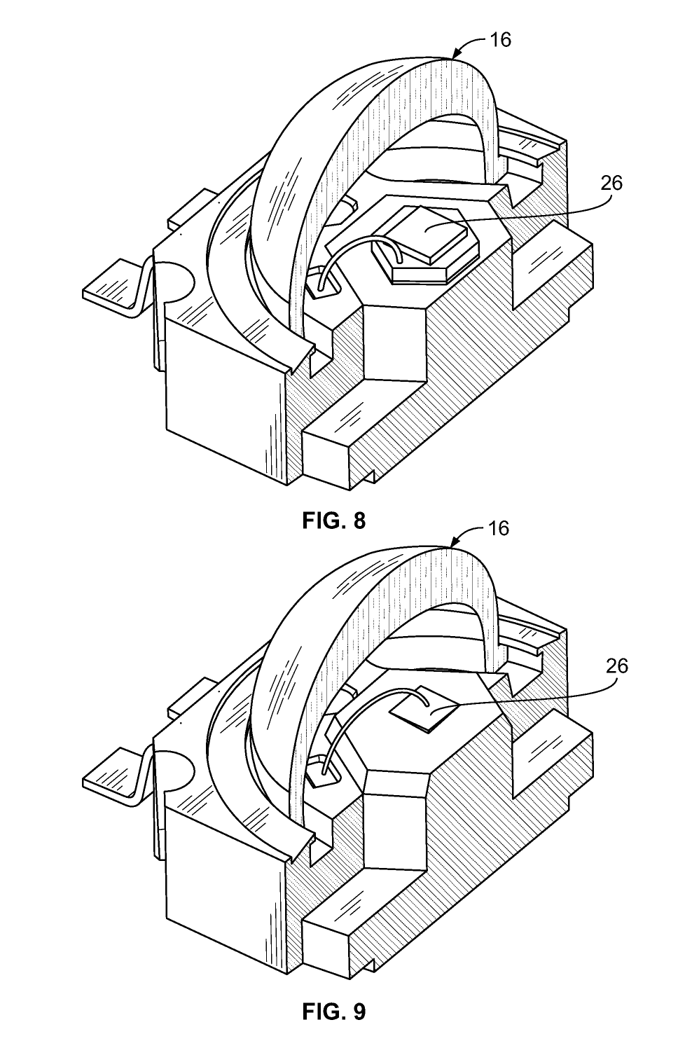

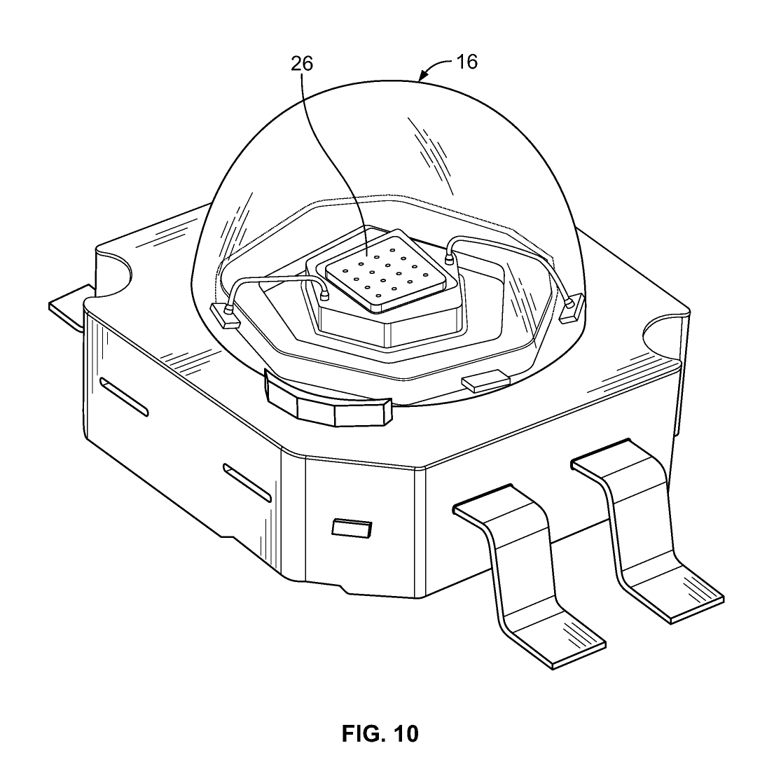

In the preferred embodiment, the light source 16, as shown in FIGS. 1, 2, 3, 8, 9 and 10, comprises a light emitting diode (LED) 26. In a most preferred embodiment, the light source is a single white LED such as Lumileds™ Luxeon® K2 white LED at 100 lumens output, however, any color of light may be used including, but not limited to, red, green, and blue LEDs without departing from the scope of the invention. In an embodiment, all three primary color LEDs may be used in any combination as a light source in order to generate light of varying colors. These red, green, and blue LEDs may also be combined in any combination with a white LED to form the light source used with the invention. The light source used with the inventive system may include its own cathode lead and thermal heat sink. In the preferred embodiment, the color range of the light source is approximately 5700-6400° Kelvin. In other embodiments, other color ranges may be utilized.

As shown in FIGS. 1, 3 and 4, the optical housing 12 is combined with fixing features 28 (i.e., 3 legs) to allow attachment of the optical housing to the LED electrical board 30 via heat staking or adhesive. In the embodiment in FIGS. 1-4, the lens has a generally flat top output surface 20. This generally flat top output surface 20 allows for the use of a texture on it that helps with the lit and unlit appearance of the light and also helps to minimize possible lighting defects along with minimizing the potential for dirt to collect on the surface. The internal walls of the optical housing may have a coating to adjust illumination patterns and light levels. Similarly, applying a matte finish, frosting or other texture to at least a portion of the lens allows for adjustment to the illumination pattern and light levels. In the preferred embodiment, the lighting apparatus has an optical efficiency that is greater than approximately 75%. In alternative embodiments other optical efficiencies may be used.

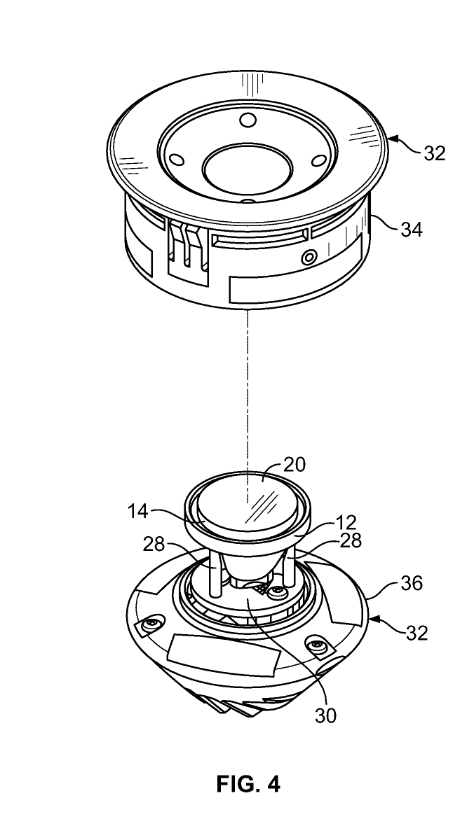

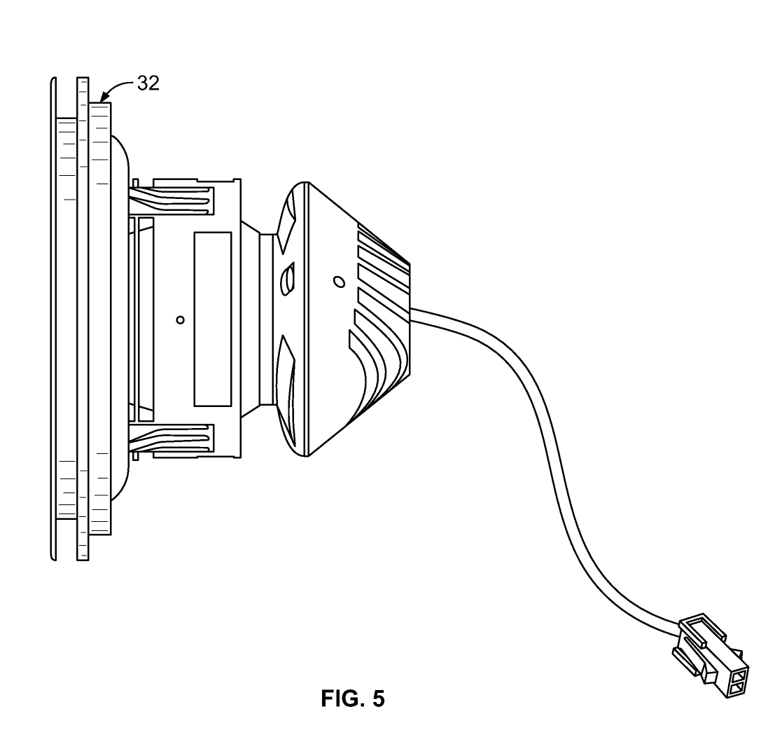

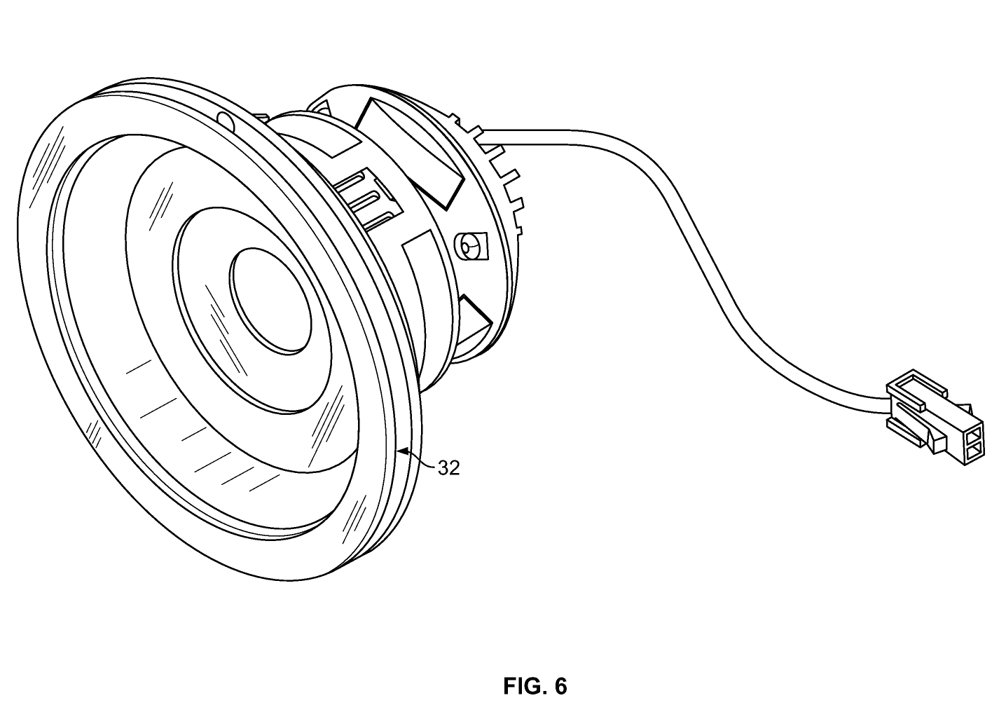

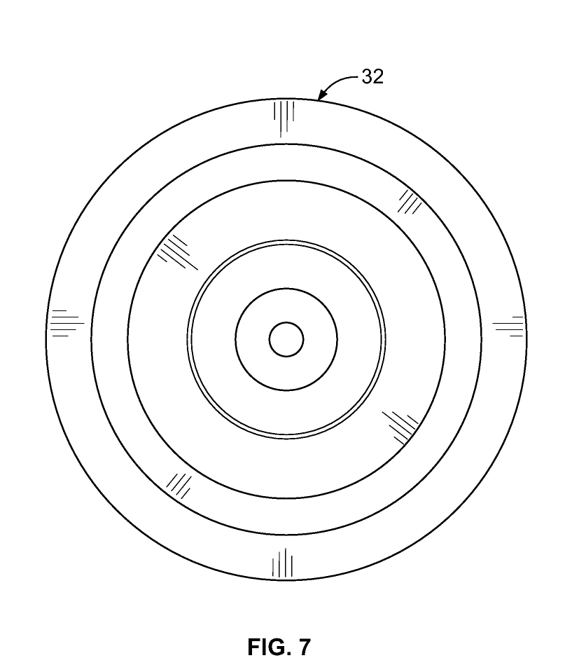

As seen in FIGS. 4-5, the lens and optical housing are disposed in an external housing 32 surrounding the optical housing 12. In the preferred embodiment, the external housing 32 has an upper 34 and lower 36 portion and the optical housing 12 and LED electrical board 30 are attached to the lower portion 36 of the external housing 32 and the lens 14 fits through an opening in the top surface of the upper portion 34 of the external housing 32. The external housing, in a preferred embodiment, may have a facetted internal surface as shown in FIGS. 6-7.

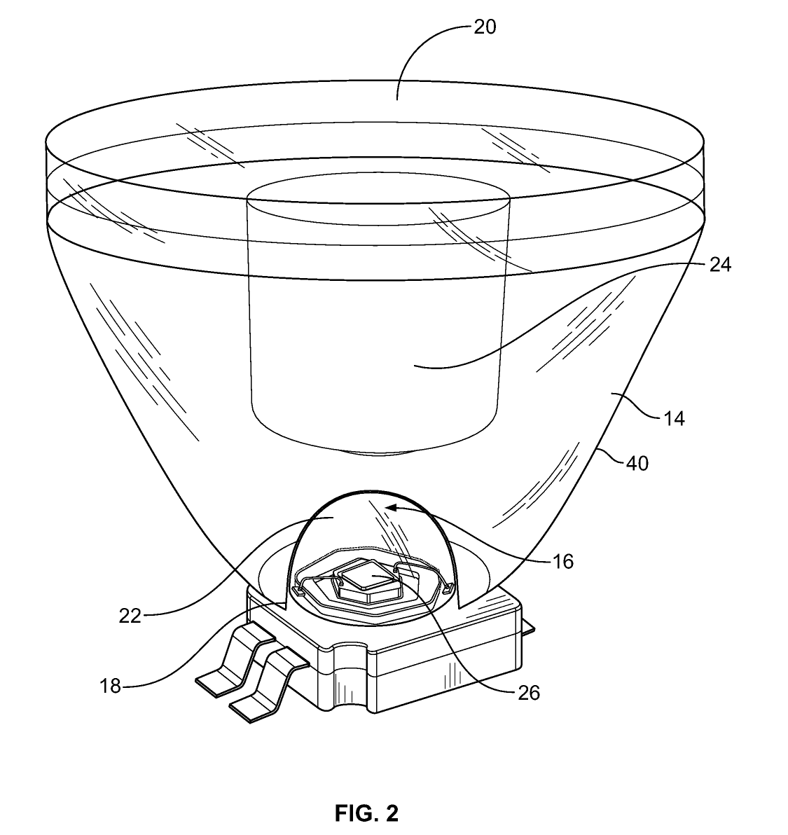

When in operation, a light is emitted from the light source (e.g., LED) located in the focal point of the optical housing. A portion of the emitted light will travel through the lens to the air cavity and ultimately out of the top output surface of the lens. Another portion of the emitted light will be collimated by the lens sidewalls 40 (FIG. 2) before exiting the lens. Although not limited to this shape, in the preferred embodiment, the lens sidewalls are generally parabolic in shape to aid in the collimation of emitted light. The emitted light rays that travel from the polycarbonate portion of the lens through the air cavity undergo refraction thus helping to minimize hot spots near the center of the output surface of the lens and producing a less concentrated or focused beam of light in the center of the illuminated target area.

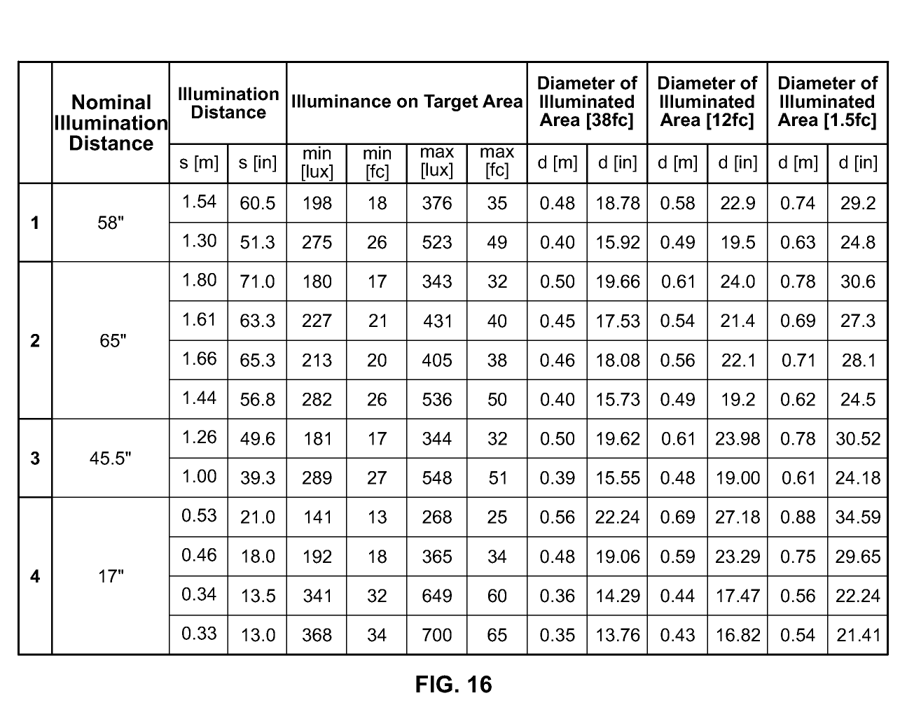

FIG. 16 shows the minimum and maximum illuminance on a target area at a given distance from the top output surface of the lens. The luminance may not be uniform across the entire target area. FIG. 16, shows the diameter of the illuminated area at 38, 12 and 1.5 footcandles for a representative sample of illumination distances.

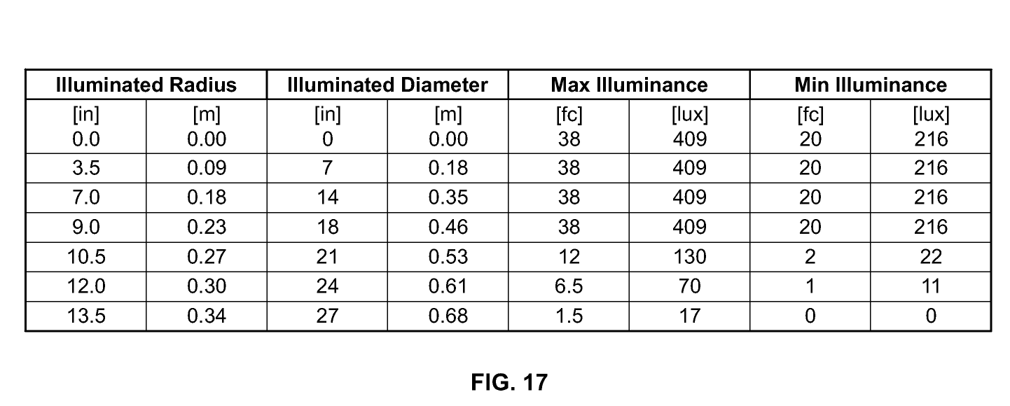

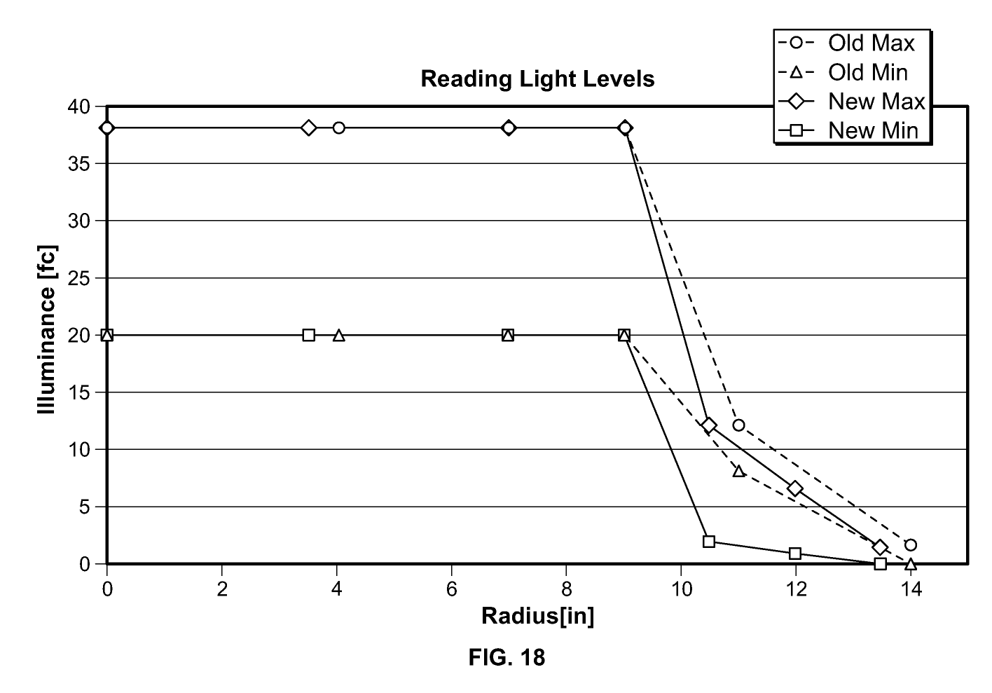

FIG. 18 illustrates a representative comparison of luminance at a given distance between existing current light apparatus and the inventive light apparatus that is the subject of this application. FIG. 18 illustrates the much sharper drop off of luminance of the inventive light apparatus as compared to the drop off in the prior art. FIG. 17 lists the points plotted on FIG. 18 for the inventive light apparatus. FIGS. 17-18 demonstrate, for example, at about 0 inches from the center of the target illuminated area, the maximum luminance is about 38 footcandles and the minimum is about 20 footcandles. At approximately 10.5 inches from the center of the target illuminated area, the maximum luminance is approximately 12 footcandles and the minimum luminance is approximately 2 footcandles for the inventive light apparatus. As can be seen from FIG. 18, both the maximum luminance (12 footcandles) and the minimum luminance (2 footcandles) of the inventive light apparatus are significantly below the corresponding luminance, at the same distance from the center of the target illuminated area, of existing light apparatus.

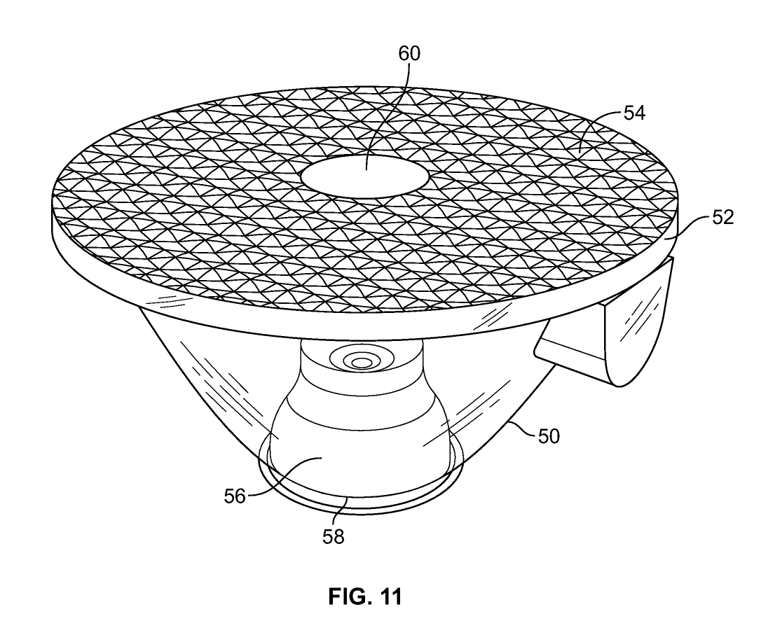

In another embodiment of the invention illustrated in FIG. 11, a generally conical shaped optical housing 50 is attached to an optical surface 52 comprised of a plurality of micro-lenses 54. A light source 56 is disposed in the focal point 58 of the optical housing 50. A dimple 60 is disposed in the center of the optical surface 52 and is aligned with the light source 56. The conical shape of the side walls of the optical housing collimate light received from the light source into generally parallel light rays. The micro-lenses receive the generally parallel light rays and spread the light into a prescribed light distribution, thereby providing for a more comfortable reading environment. The dimple reduces on-axis light intensity from the light source.

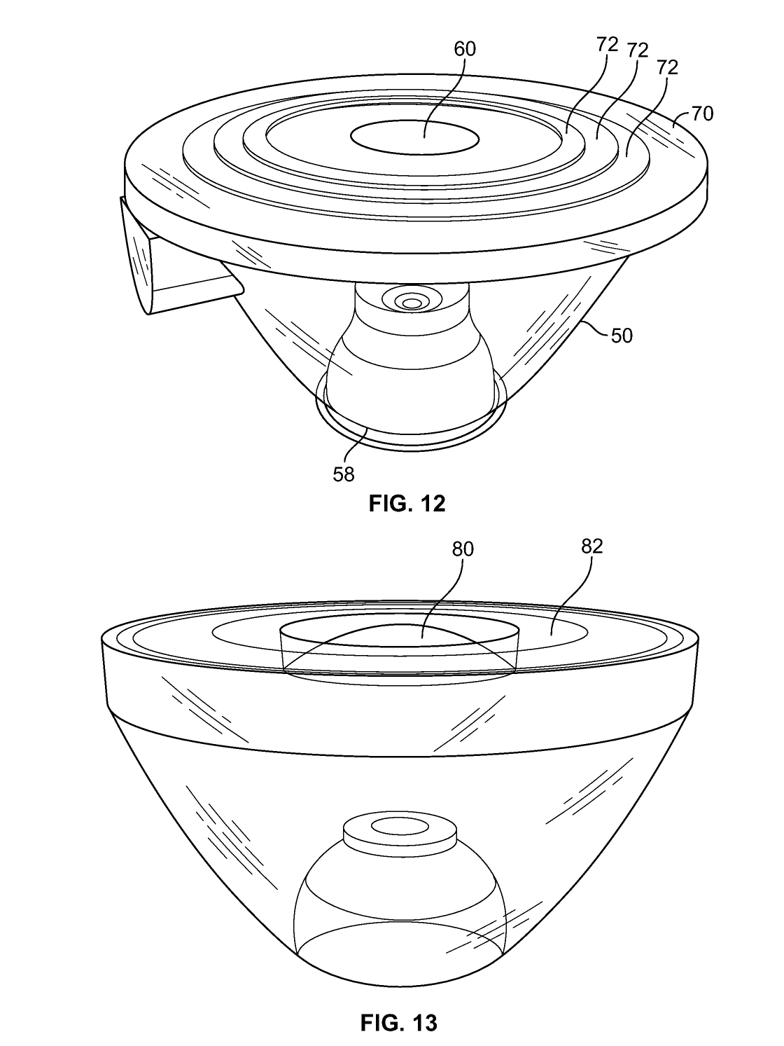

In other embodiments, other optical surfaces suitable for light distribution may be used. As shown in FIG. 12, in another embodiment the optical surface 70 has stepped concentric rings 72 that distribute the received light rays. In the embodiments, as shown in FIGS. 11 and 12, the optical surface defines an indentation (a dimple), where the indentation is located opposite the focal point 58 of the optical housing 50. This central dimple reduces the on-axis intensity of the light source. In yet another embodiment as shown in FIG. 13, a convex lens 80 may be positioned in the approximate center of a top surface 82 to focus the received light in order to increase on-axis light intensity. In an alternative embodiment, the sides of the optical housing of FIG. 13 may be facetted (not shown in FIG. 13). This facetted surface breaks up the light pattern and provides more control via the facetted edges of the surface.

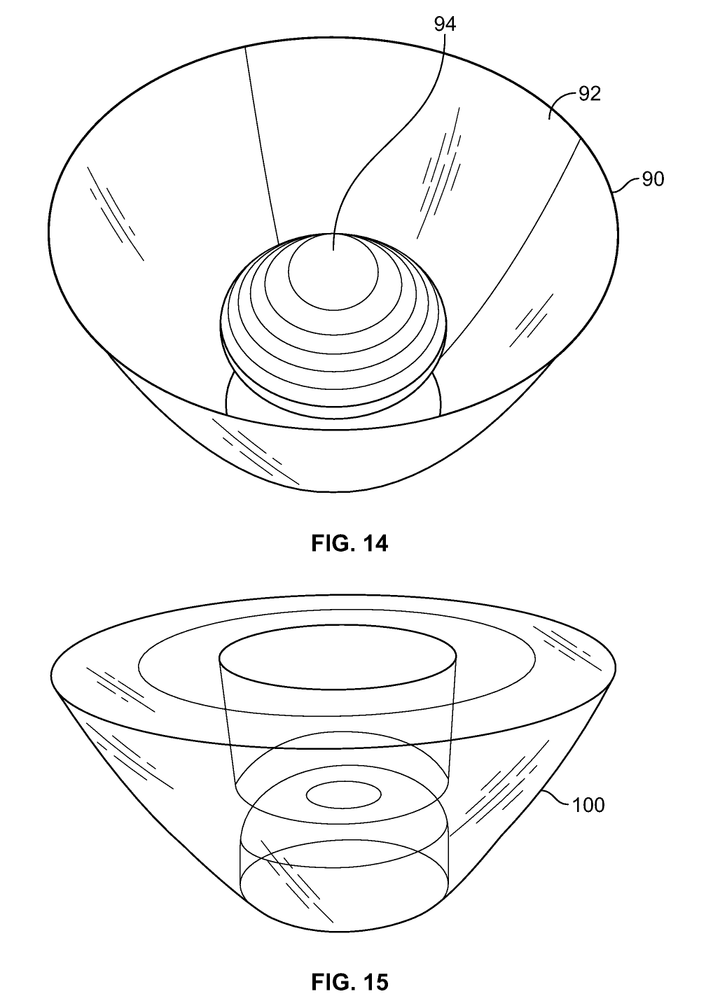

In an embodiment shown in FIG. 14, the optical housing 90 may be comprised of a generally ellipsoidal mirror 92 and a focus lens 94 is positioned within the housing 90. The combination of this ellipsoidal mirror and focus lens provides more control over the on-axis light and the “cut-off” of the light distribution radius from a light source such as an LED. In another embodiment shown in FIG. 15, the ellipsoidal mirror of FIG. 14 is not used and instead the interior sidewalls of the housing 100 collimate the light received from the light source.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A lighting apparatus comprised of:
a generally conical shaped first housing having a focal point;
a light source disposed in the focal point of the first housing; and
a lens surrounding at least a portion of the light source and enclosing a cavity aligned with the light source, wherein an output surface of the lens is distal from the focal point of the first housing.

2. The lighting apparatus of claim 1, wherein the light source is a light-emitting diode.

3. The lighting apparatus of claim 1, wherein the output surface is texturized.

4. The lighting apparatus of claim 1, wherein the cavity is an air cavity.

5. The lighting apparatus of claim 1, wherein the lens is polycarbonate.

6. The lighting apparatus of claim 1, wherein a coating has been applied on at least a portion of the exterior of the lens.

7. The lighting apparatus of claim 1, wherein the cavity is vertically aligned with the light source.

8. The lighting apparatus of claim 1, wherein the color range of the light source is approximately 5700-6400° Kelvin.

9. The lighting apparatus of claim 1, wherein the lighting apparatus has an optical efficiency greater than 75%.

10. A lighting apparatus comprised of:
a lens enclosing an air cavity and having a recessed portion and an top output surface;
a light source disposed adjacent to the recessed portion of the lens; and
a first housing at least partially surrounding the lens.

11. The lighting apparatus of claim 10, wherein the light source is a light-emitting diode.

12. The lighting system of claim 11, wherein the color range of the light source is approximately 5700-6400° Kelvin.

13. The lighting system of claim 12, wherein the lighting apparatus has an optical efficiency greater than 75%.

14. The lighting system of claim 10, wherein the lens is polycarbonate.

15. The lighting system of claim 10, wherein the top output surface is texturized.

16. The lighting system of claim 10, wherein a coating has been applied on at least a portion of the lens.

17. The lighting system of claim 10, further comprising a second housing surrounding the first housing.

18. The lighting system of claim 17 further comprising an electrical board disposed on a lower portion of the second housing, wherein the first housing is attached to the electrical board.

19. The lighting system of claim 18, wherein the lens top output surface is substantially flat.

20. A lighting system comprised of:
a generally conical shaped lens enclosing an air cavity and having a bottom recessed portion and a generally flat top surface;
a single light emitting diode disposed in the recessed portion of the lens, wherein the light emitting diode is distal from the top surface of the lens;
a first housing at least partially surrounding the lens, wherein the first housing is attached to an electrical board connected to the light emitting diode; and
a second housing at least partially enclosing the first housing, the light emitting diode and the electrical board.
